(19) United States
(12) Patent Application Publication
(10) Pub. No.: US 2026/0209567 A1
(43) Pub. Date: Jul. 23, 2026

(54) SILICONE-BASED PRESSURE SENSITIVE ADHESIVE LAYER-FORMING COMPOSITION AND USE THEREOF

(71) Applicants: DOW SILICONES CORPORATION, Midland, MI (US); DOW TORAY CO., LTD., Shinagawa-Ku, Tokyo (JP)

(72) Inventors: Jingui JIANG, Shanghai (CN); Maki ITOH, Ichihara-shi, Chiba (JP); Chao ZHOU, Shanghai (CN); Guodong SHEN, Shanghai (CN); Jiayin ZHU, Shanghai (CN); Chengrong ZHU, Shanghai (CN); Qing CAO, Shanghai (CN); Zhihua LIU, Shanghai (CN)

(21) Appl. No.: 19/142,193

(22) PCT Filed: Dec. 23, 2022
(86) PCT No.: PCT/CN2022/141214

§ 371 Date: Jun. 21, 2025

(51) Int. Cl. C09J 7/38; C09J 11/04; C09J 11/06; C09J 11/08; C09J 183/04

(52) U.S. Cl. CPC C09J 7/38; C09J 11/04; C09J 11/06; C09J 11/08; C09J 183/04; C09J 2203/326; C09J 2301/302

(57) ABSTRACT

A silicone-based pressure sensitive adhesive (PSA) layer-forming composition comprises: (A) a linear organopolysiloxane having greater than one alkenyl group on average per molecule; (B) an organopolysiloxane resin, wherein the total content of hydroxyl groups and hydrolysable groups with respect to all silicon atoms in the molecule is 2.0 mass % or less; (C) an organohydrogenpolysiloxane having at least two Si—H bonds in the molecule; (D) at least one of tetraalkoxysilane or a prepolymer thereof; and (E) a hydrosilylation reaction catalyst. The mass ratio of components (B) to (A) is within a range of 0.5 to 3.5. The amount of component (D) based on total mass of components (A) to (C) is within a range of 0.1 to 9.0 mass %. The composition can form a PSA layer which has excellent curability due to a hydrosilylation reaction, has improved adhesion force as well as lower Tg/modulus at lower temperature with softness properties.

### CROSS REFERENCE TO RELATED APPLICATIONS

None.

### TECHNICAL FIELD

The present invention relates to a curing reactive organopolysiloxane composition that forms a pressure sensitive adhesive layer (i.e., a silicone-based pressure sensitive adhesive layer-forming composition) having greater adhesive force by using at least one tetraalkoxysilane or a prepolymer of the tetraalkoxysilane as anchorage additive. Moreover, the present invention relates to a pressure sensitive adhesive composition that uses the composition, along with applications such as laminated bodies, electronic parts, or display devices (including flexible displays, foldable displays, automotive displays, and touch panels, etc.) that use the composition.

### BACKGROUND

Polysiloxane pressure sensitive adhesive (PSA) compositions have excellent electrical insulating properties, heat resistance, cold resistance, and adhesion to various substrates and adherends in comparison to acrylic or rubber based pressure sensitive adhesive compositions, facilitating the usage thereof in heat resistant adhesive tapes, electrically insulating adhesive tapes, heat seal tapes, plating masking tapes, and the like. These polysiloxane pressure sensitive adhesive compositions are classified into addition reaction curing types, condensation reaction curing types, peroxide curing types, and the like in accordance with the curing mechanisms thereof. Addition reaction curing type pressure sensitive adhesive compositions are widely used because the compositions cure quickly when left to stand at room temperature or by heating and do not generate any by-products.

Taking advantages of the above characteristics of polysiloxane pressure sensitive adhesives composition as well as characteristics which can achieve high transparency thereof as required, applications in the field of advanced electronic materials and display elements such as smart devices have been investigated in recent years. Such a device assumes a structure in which a film made up of a plurality of layers including an electrode layer and a display layer is sandwiched between transparent substrates, with a polysiloxane pressure sensitive adhesive composition having excellent heat resistance and cold resistance expected to work effectively for the purpose of protecting the electrode layer and the display layer and improving adhesion between the layers.

In particular, in recent material development, there has been a need for a polysiloxane pressure sensitive adhesive composition which has a relatively low storage elastic modulus (for example, shear storage elastic modulus G′) in a wide temperature region, including lower temperatures such as −20° C., etc., has excellent curability, and has sufficient adhesion for practical use. For example, we have already proposed various silicone-based PSA (including optically clear adhesive (OCA)) layer-forming compositions and its application in Patent Documents 1 to 4. In these patent documents, we have proposed silicone-based PSA layers having lower Tg and lower modulus value at low temperature.

On the other hand, however, we found that such silicone-based PSA layers having lower Tg and lower modulus tend to have lower adhesive force. For this trade-off relationship between adhesive force and low Tg/modulus in silicone-based PSA layer, there is a potential problem that said silicone-based PSA layer cannot be applied in some applications requiring strong adhesive force in assembly/bonding layers or units in the lamination body, electronic device (e.g. display) and articles.

On the other hand, hydrolysable silanes are broadly applied in curable silicone compositions as crosslinker in condensation reaction-curable silicones or silane coupling agent as additive or treating agent for some components (see Patent Documents 5 to 8). However, there is no disclosure or suggestion of applying specific tetraalkoxysilane(s) in addition reaction curable silicone-based pressure sensitive adhesive composition to enhance its adhesion force.

Patent documents 9 and 10 disclose addition reaction curable silicone-based adhesive compositions which can comprise silanes such as vinyltriacetoxysilanes and glycidoxypropyltrimethoxysilanes. However, there is no disclosure or suggestion of applying specific tetraalkoxysilanes as anchorage additive to enhance its adhesion force. Furthermore, curable PSA composition disclosed in said Patent documents 9 and 10 cannot provide low Tg or low modulus property in cured PSA layer. Also, since molar ratio of Si—H bonds to alkenyl groups (i.e., SiH/Vi ratio) in the composition is too low in Patent document 9, the cured PSA layer tend to show cohesive failure with a low adhesion value. That is to say, there is no disclosure or substantive suggestion to use tetraalkoxysilane selectively as anchorage additive to solve the trade-off relationship between adhesive force and low Tg/modulus in silicone-based PSA layer.

### RELATED ART DOCUMENTS

### Patent Documents

[Patent Document 1] WO2020032286A1
[Patent Document 2] WO2020032287A1
[Patent Document 3] WO2020032285A1
[Patent Document 4] WO2022138913A1
[Patent Document 5] US20100059171A1
[Patent Document 6] US20140356620A1
[Patent Document 7] JP2000017246A
[Patent Document 8] U.S. Pat. No. 5,561,203A
[Patent Document 9] WO2021000279A1
[Patent Document 10] WO2020248181A1

### SUMMARY

### Problems to be Solved

The present invention has been created in order to solve the abovementioned problems, and an objective thereof is to provide a curing reactive organopolysiloxane composition which forms a pressure sensitive adhesive layer having improved and higher adhesive force with a low storage elastic modulus (G′)/Tg property without impairing its curability. Another objective of the present invention is to provide use of the curing reactive organopolysiloxane composition or a cured product thereof as a pressure sensitive adhesive layer and use of the same as an elastic adhesive member having improved adhesive force in various applications, along with equipment and devices provided with the same.

### Means for Solving the Problem

As a result of conducting diligent research on the problems described above, the present inventors arrived at the present invention. That is, one object of the present invention is achieved by a specific hydrosilylation reaction-curable pressure sensitive adhesive layer-forming organopolysiloxane composition comprising at least one of tetraalkoxysilane or a prepolymer of the tetraalkoxysilane as anchorage additive. In comparison with the pressure sensitive adhesive layer obtained from the same or similar composition but lacking said tetraalkoxysilane or a prepolymer thereof as anchorage additive, the inventive pressure sensitive adhesive layer can show more than 20% greater adhesive force. Furthermore, the tetraalkoxysilane as anchorage additive does not impair low Tg/modulus property in the silicone-based pressure sensitive adhesive layer.

Specifically, the problems described above can be solved by a silicone-based pressure sensitive adhesive layer-forming composition comprising components (A) to (E):
(A) a linear organopolysiloxane having alkenyl group in numbers greater than 1 on average per molecule;
(B) an organopolysiloxane resin, wherein the total content of hydroxyl groups and hydrolysable groups with respect to all silicon atoms in molecules is 2.0 mass % or less;
(C) an organohydrogenpolysiloxane having at least two Si—H bonds per molecule;
(D) at least one of tetraalkoxysilane or a prepolymer of the tetraalkoxysilane; and
(E) a hydrosilylation reaction catalyst, wherein the mass ratio of component (B) to component (A) is within a range of 0.5 to 3.5, and the amount of component (D) based on total mass of components (A) to (C) is within a range of 0.1 to 9.0 mass %.

In an embodiment according to the present disclosure, the silicone-based pressure sensitive adhesive layer-forming composition further comprises (A′) a linear organopolysiloxane which does not contain any carbon-carbon double bond-containing reactive groups in the molecule. In a preferred embodiment of this invention, at least a portion of said components (A) and (A′) is a raw rubber-like organopolysiloxane having a viscosity of 100,000 mPa·s or more at 25° C. or having a plasticity number within a range of 50 to 200 as measured in accordance with a method as described in JIS K6249.

In addition, the problems described above can be solved through the use of these silicone-based pressure sensitive adhesive layer-forming compositions or cured products thereof as a pressure sensitive adhesive layer, the use of the same as an electronic material or a member for a display device, and an electronic part or a display device provided with the same.

### Effects of this Invention

Through this invention, the trade-off relationship between higher adhesion force and lower Tg or modulus at lower temperature in the silicone-based pressure sensitive adhesive layer can be overcome to some extent. That is to say, the silicone-based pressure sensitive adhesive layer-forming composition according to the present invention can form a pressure sensitive adhesive layer which has excellent curability due to a hydrosilylation reaction, has improved adhesion force as well as lower Tg/modulus at lower temperature with softness properties of low modulus at small deformation, low stress at large deformation and larger creep compliance etc. Further, the silicone-based pressure sensitive adhesive layer-forming composition or a cured product thereof can be suitably used as a pressure sensitive adhesive layer, electronic material, or a member for a display device, and the electrical or electronic part or display device provided with the same satisfies the abovementioned required characteristics. Therefore, the pressure sensitive adhesive layer can be applied to a substrate of an electronic component etc. in a temperature region including lower temperatures to room temperature, thus advantageously facilitating industrialization, such that improvements in the performance of a laminated body such as the resulting display device are expected. In particular, this invention can provide lower Tg or modulus as well as higher adhesion force in the silicone-based pressure sensitive adhesive layer without affecting the rheological/viscoelastic properties for the silicone-based pressure sensitive adhesive layer. It will good help to expand the application and potential market of silicone-based pressure sensitive adhesive layer including optically-clear adhesive (OCA) applied for various display devices and electronic articles.

### DETAILED DESCRIPTION

### [Silicone-Based PSA-Forming Composition]

First, the silicone-based pressure sensitive adhesive (PSA) layer-forming composition according to the present invention will be described. The composition rapidly cures via a curing reaction containing a hydrosilylation reaction so as to form a pressure sensitive adhesive layer having improved adhesion force as well as a relatively low shear storage elastic modulus G′ at −20° C. and Tg properties. Hereinafter, each component in the composition, the range of the organopolysiloxane resin, the mass ratio of the organopolysiloxane resin to the linear organopolysiloxane, and the characteristics of the pressure sensitive adhesive layer will be described below.

As described above, the composition according to the present invention is characterized by comprising at least one of tetraalkoxysilane or a prepolymer of the tetraalkoxysilane as anchorage additive to improve the adhesion force without affecting the rheological/viscoelastic properties for the silicone-based pressure sensitive adhesive layer. Thus, this invention can provide a silicone-based pressure sensitive adhesive layer having an improved adhesion force as well as lower Tg/modulus at lower temperature with softness properties.

In an embodiment according to this invention, the silicone-based PSA-forming composition comprises components (A) to (E):
(A) a linear organopolysiloxane having alkenyl group in numbers greater than 1 on average per molecule;
(B) an organopolysiloxane resin, wherein the total content of hydroxyl groups and hydrolysable groups with respect to all silicon atoms in the molecule is 2.0 mass % or less;
(C) an organohydrogenpolysiloxane having at least two Si—H bonds in the molecule;
(D) at least one of tetraalkoxysilane or a prepolymer of the tetraalkoxysilane; and
(E) a hydrosilylation reaction catalyst;
wherein the mass ratio of component (B) to component (A) is within a range of 0.5 to 3.5; and
the amount of component (D) based on combined weights of components (A) to (C) is within a range of 0.1 to 9.0 mass %, 0.1 to 7.0 mass %, 0.1 to 5.0 mass %, 0.1 to 3.0 mass %, 0.1 to 1.0 mass %, 1.0 to 9.0 mass %, 1.0 to 7.0 mass %, 1.0 to 5.0 mass %, 1.0 to 3.0 mass %, 3.0 to 9.0 mass %, 3.0 to 7.0 mass %, 3.0 to 5.0 mass %, 5.0 to 9.0 mass %, 5.0 to 7.0 mass %, 7.0 to 9.0 mass %.

In a further embodiment according to this invention, the silicone-based PSA-forming composition may further comprise (A′) a linear organopolysiloxane which does not contain a carbon-carbon double bond-containing reactive group in the molecule.

In addition, since the composition contains a hydrosilylation reaction catalyst, the composition may further contain (F) a curing retarder from the perspective of handleability, and may further contain other additives to such an extent that is not at odds with the object of the present invention.

In this invention, component (A) is a linear (i.e., chain-form) organopolysiloxane having alkenyl group in numbers greater than 1 on average per molecule, with a preferable number of alkenyl groups being no less than 1.5 per molecule, with a more preferable number of alkenyl groups being no less than 2.0 per molecule. In some embodiments according to this invention, the number of alkenyl groups on average per molecule may be in range from 1.01 to 5.0, from 1.01 to 4.0, from 1.01 to 3.0, from 1.01 to 2.0, from 1.01 to 1.5, from 1.5 to 5.0, from 1.5 to 4.0, from 1.5 to 3.0, from 1.5 to 2.0, from 2.0 to 5.0, from 2.0 to 4.0, from 2.0 to 3.0, from 3.0 to 5.0, from 3.0 to 4.0 or from 4.0 to 5.0. Examples of the alkenyl groups of component (A) include alkenyl groups having a carbon number of from 2 to 10, such as vinyl groups, allyl groups, butenyl groups, pentenyl groups, hexenyl groups, and heptenyl groups, with vinyl groups or hexenyl groups being particularly preferable. Examples of the bonding position of the alkenyl groups of component (A) include the molecular chain terminals and/or the molecular side chains. Note that component (A) may contain a single component or may be a mixture of two or more different components.

Examples of silicon-bonded organic groups other than alkenyl groups in the organopolysiloxane of component (A) include alkyl groups such as methyl groups, ethyl groups, propyl groups, butyl groups, pentyl groups, hexyl groups and heptyl groups; aryl groups such as phenyl groups, tolyl groups, xylyl groups and naphthyl groups; aralkyl groups such as benzyl groups and phenethyl groups; and halogenated alkyl groups such as chloromethyl groups, 3-chloropropyl groups and 3,3,3-trifluoropropyl groups, with methyl groups and phenyl groups being particularly preferable.

In this invention, component (A) is different from component (B) and has a linear organopolysiloxane molecular structure. For example, component (A) is preferably a straight chain or partially branched straight chain and may partially include a cyclic three-dimensional network. Preferably, the main chain of the organopolysiloxane consists of repeating diorganosiloxane units (i.e., —SiO_{2/2} or D units) and is preferably a straight-chain or branched-chain diorganopolysiloxane capped at both molecular terminals with triorganosiloxy groups. Note that the siloxane units that provide a branched-chain organopolysiloxane are T units or Q units described below.

The properties of component (A) at room temperature may be those of an oily or raw rubber-like substance, with the viscosity of component (A) being no lower than 50 mPa·s and particularly preferably no lower than 100 mPa·s at 25° C. In particular, when the linear organopolysiloxane composition according to the present invention is a solvent type, at least a portion of component (A) is (A1) a raw rubber-like alkenyl group-containing organopolysiloxane having a viscosity of no less than 100,000 mPa·s at 25° C. or having a plasticity number (the thickness when a 1 kgf load applied for 3 minutes to a 4.2 g spherical sample at 25° C. was read up to 1/100 mm and this value was multiplied by 100) within a range of from 50 to 200, preferably 80-200, more preferably 100-200, as measured in accordance with the method as prescribed in JIS K6249.

Note that in order to prevent contact failure, etc., volatile or low molecular weight siloxane oligomers (such as octamethylcyclotetrasiloxane (D4), decamethylcyclopentasiloxane (D5), etc.) in the organopolysiloxanes alkenyl group are preferably reduced or eliminated. The degree can be designed as desired, but must be less than 1% by mass of the total component (A), less than 0.1% by mass for each siloxane oligomer, and must be reduced to the vicinity of the detection limit as required.

Although the content of alkenyl groups in component (A1) is not particularly limited, the content of the vinyl (CH₂═CH) portion in the alkenyl groups in component (A1) (hereinafter, referred to as the “vinyl content”) may be in the range of from 0.005 to 0.400 mass %, preferably in the range of from 0.005 to 0.300 mass %, and particularly preferably in the range of from 0.005 to 0.200 mass %.

In some embodiments according to the present invention, component (A) having a lower viscosity than that of component (A1) is also available as component (A) of the present invention. Specifically, an organopolysiloxane (A2) containing alkenyl groups having a viscosity of less than 100,000 mPa·s at 25° C. is available. Here, examples other than the viscosity of component (A2) are the same as component (A1).

In the present invention, 50 mass % or more of component (A) is preferably an alkenyl group-containing organopolysiloxane with a high degree of polymerization, which is component (A1), with 75 to 100 mass % thereof being particularly preferably component (A1). That is, when component (A1) (=an alkenyl group-containing organopolysiloxane with a higher degree of polymerization) and component (A2) (=an alkenyl group-containing organopolysiloxane with a lower degree of polymerization) are used in combination as component (A) of the present invention, the mass ratios of component (A1) to component (A2) range from 50:50 to 100:0, preferably 75:25 to 100:0, more preferably 75:25 to 90:10.

In this invention, the organopolysiloxane resin of component (B) is an adhesion imparting component imparting adhesive force to a substrate and simultaneously achieves a storage elastic modulus at low temperatures and a practical adhesive force range, using an organopolysiloxane resin mixture in a constant ratio to component (A). More specifically, component (B) is an organopolysiloxane resin having a small average molecular weight, wherein the content of hydroxyl groups or hydrolyzable groups is suppressed, and wherein a hydrolysis/polymerization reaction between components (B) tends not to occur, while the selective use of an organopolysiloxane resin having a small average molecular weights achieves a predetermined storage elastic modulus and practical adhesive force range in the pressure sensitive adhesive layer which is the cured product thereof.

Specifically, component (B) is an organopolysiloxane resin, wherein the total content of hydroxyl groups and hydrolyzable groups with respect to the number of all silicon atoms in the molecule is 2.0 mass % or less, 1.6 mass % or less, 1.5 mass % or less, 1.2 mass % or less. Note that in component (B), the content of such hydroxyl groups and hydrolyzable groups can be expressed by converting all of these functional groups into hydroxyl groups. In this case, when the mass % is calculated assuming that all of the hydrolyzable groups other than the hydroxyl groups in the organopolysiloxane resin molecule are hydroxyl groups (OH), the sum of the content of the abovementioned hydroxyl groups and hydrolyzable groups can be expressed such that the content of these hydrolyzable groups which are converted into hydroxyl groups and hydroxyl groups in the organopolysiloxane resin molecule is 2.0 mass % or less, 1.6 mass % or less, 1.5 mass % or less, 1.2 mass % or less. The hydroxyl groups or hydrolysable groups are groups which are directly bonded to silicon atoms of T units or Q units, etc. among the siloxane units in the below-mentioned resin structure and obtained by hydrolyzing silanes or silane derivatives. Consequently, the content of hydroxyl groups or hydrolyzable groups can be reduced by hydrolyzing the synthesized organopolysiloxane resin with a silylating agent such as trimethylsilane.

In component (B), when the amount of the hydroxyl groups or hydrolyzable groups exceeds the abovementioned upper limit, the condensation reaction between the organopolysiloxane resin molecules proceeds, facilitating the formation of an organopolysiloxane resin structure having a large molecular weight in the cured product. Such an organopolysiloxane resin having a high molecular weight tends to impair the curability of the overall composition, the curability of the composition at low temperatures may be insufficient, and the resulting pressure sensitive adhesive layer may not have sufficient storage elastic modulus for practical use.

In this invention, component (B) is an organopolysiloxane resin having a three dimensional structure. Examples thereof include a resin consisting of R₂SiO_{2/2} units (D units) and RSiO_{3/2} units (T units) (wherein, each R independently represents a monovalent organic group) and having a content of hydroxyl groups or hydrolyzable groups within the abovementioned range, a resin consisting of only T units and having a content of hydroxyl groups or hydrolyzable groups within the abovementioned range, and a resin consisting of R₃SiO_{1/2} units (M units) and SiO_{4/2} units (Q units) and having a content of hydroxyl groups or hydrolyzable groups within the abovementioned range. In particular, resin (also referred to as MQ resin) is preferably used which consists of R₃SiO_{1/2} units (M units) and SiO_{4/2} units (Q units), wherein the sum of the content of hydroxyl groups and hydrolyzable groups is preferably within a range of 0.0 to 1.6 mass % when all of these functional groups are converted into hydroxyl groups.

The monovalent organic group of R is preferably a monovalent hydrocarbon group having a carbon number of from 1 to 10, with examples thereof including alkyl groups having a carbon number of from 1 to 10, alkenyl groups having a carbon number of from 2 to 10, aryl groups having a carbon number of from 6 to 10, cycloalkyl groups having a carbon number of from 6 to 10, benzyl groups, phenylethyl groups and phenylpropyl groups. In particular, 90 mole % or more of R is preferably alkyl groups having 1 to 6 carbon atoms or phenyl groups, while 95 to 100 mole % of R is particularly preferably methyl groups or phenyl groups.

Preferably, component (B) is (B1) an organopolysiloxane resin or mixture thereof which consists essentially of R₃SiO_{1/2} units and SiO_{4/2} units, where R is a monovalent organic group and 90 mole % or more of R is an alkyl group having 1 to 6 carbon atoms or a phenyl group. When component (B) is a resin consisting of R₃SiO_{1/2} units (M units) and SiO_{4/2} units (Q units), the molar ratio of M units to Q units is preferably from 0.5 to 2.0. This is because when the molar ratio is less than 0.5, the adhesive force to the substrate may be diminished, whereas when the molar ratio is greater than 2.0, the cohesive strength of the material constituting the adhesive layer decreases. Moreover, D units and T units may also be included in component (B) to such an extent that does not impair the characteristics of the present invention. Further, in order to prevent contact failure, etc., low molecular weight siloxane oligomer in these organopolysiloxane resins may be reduced or eliminated.

In the present invention, the weight average molecular weight (Mw) of said organopolysiloxane resin serving as component (B) is not limited, and at least one organopolysiloxane resin having specific Mw or a mixture of two or more of organopolysiloxane resin having different Mw can be used as component (B). From practical viewpoint, Mw of component (B) measured in terms of standard polystyrene by gel permeation chromatography (GPC) ranges from 500 to 20,000 (g/mol), preferably from 1,000 to 17,500 (g/mol), most preferably from 2,000 to 16,500 (g/mol).

### [Mass Ratio of Component (B) to Component (A)]

The pressure sensitive adhesive layer-forming organopolysiloxane composition according to the present invention characteristically has a mass ratio of component (B) (which is an organopolysiloxane resin) to component (A) (which is a chain reactive siloxane component) within the specific range. In combination with component (D) as anchorage additive, the mass ratio of component (B) to component (A) is within a range of 0.5 to 3.5, 0.5 to 2.5, 0.5 to 1.5, 0.5 to 0.75, 0.75 to 3.5, 0.75 to 3.0, 0.75 to 2.5, 0.75 to 1.5, 1.5 to 3.5, 1.5 to 2.5 or 2.5 to 3.5. Specifically, if (A′) the chain organopolysiloxane which does not contain a carbon-carbon double bond-containing reactive group in the molecule is optional, the mass ratio of component (B) to component (A) is within a range of 0.9 to 1.8, 0.9 to 1.6, 0.9 to 1.4, 0.9 to 1.2, 1.2 to 1.8, 1.2 to 1.6, 1.2 to 1.4, 1.4 to 1.8, 1.4 to 1.6 or 1.6 to 1.8. In contrast, if this composition contains component (A′) and the mass ratio of component (A) to component (A′) is within a range of 95:5 to 60:40, 90:10 to 60:40, 80:20 to 60:40, 70:30 to 60:40, 90:10 to 70:30 or 80:20 to 70:30, the mass ratio of component (B) to component (A) is within a range of 0.9 to 2.4, 0.9 to 2.0, 0.9 to 1.6 or 0.9 to 1.2. In other words, if components (A) and (A′) are used at above mass ratio, even if the mass ratio of component (B) to component (A) is within a range of more than 1.8 to 2.4, the technical effects of the present invention can also be achieved.

If component (A′) is not an essential component in the composition according to the present invention, in order to achieve the desired adhesive force and storage elastic modulus, the mass ratio of component (B) to the sum of components (A) and (A′) is within a range of 0.9 to 1.8, and may be within a range of 1.0 to 1.77, 1.2 to 1.6 or 1.4 to 1.5. Note that in the case of the mass ratio of component (B) to component (A), regarding the further use of component (A′), it is one of preferred embodiments of the present invention without impairing the technical effects of the present invention.

In contrast, if component (A′) is an essential component in the composition according to the present invention and the mass ratio of component (A) to component (A′) is within a range of 95:5 to 60:40, the mass ratio of component (B) to the sum of components (A) and (A′) is within a range of 0.9 to 2.4, 0.9 to 2.0, 0.9 to 1.6 or 0.9 to 1.2, and may be within a range of 0.9 to 2.3 or within a range of 1.0 to 2.3.

In this invention, component (C) is an organohydrogenpolysiloxane having two or more Si—H bonds per molecule and is a crosslinking agent in the organopolysiloxane composition of the present invention. The molecular structure of component (C) is not particularly limited, with examples thereof including a straight chain, a partially branched straight chain, a branched chain, a cyclic, or an organopolysiloxane resin structure, and with a straight chain, a partially branched straight chain, or an organopolysiloxane resin structure being preferable. The bonding position of silicon-bonded hydrogen atoms is not particularly limited, with examples thereof including molecular terminals, side chains, or both molecular terminals and side chains. The content of the silicon-bonded hydrogen atoms is from 0.1 to 2.0 mass % preferably from 0.5 to 1.7 mass %.

Exemplary silicon-bonded organic groups in component (C) include: alkyl groups having 1 to 8 carbon atoms such as methyl groups, ethyl groups, propyl groups, butyl groups and octyl groups; aryl groups such as phenyl groups and tolyl groups; aralkyl groups such as benzyl groups and phenethyl groups; and halogenated alkyl groups such as 3-chloropropyl groups and 3,3,3-trifluoropropyl groups, wherein 50% moles or more of the total number thereof are preferably alkyl groups having 1 to 8 carbon atoms or phenyl groups. From the perspective of ease of manufacture and compatibility with the preferred components (A) and (B) described above, the other organic groups are preferably methyl groups or phenyl groups.

When component (C) of the present invention is an organohydrogenpolysiloxane, which is an organopolysiloxane resin, examples thereof include organopolysiloxane copolymers consisting of siloxane units represented by the general formula: R′₃SiO_{1/2}, siloxane units represented by the general formula R′₂HSiO_{1/2}, and siloxane units represented by the formula: SiO_{4/2}; organopolysiloxane copolymers consisting of siloxane units represented by the general formula: R′₂HSiO_{1/2} and siloxane units represented by the formula: SiO_{4/2}; organopolysiloxane copolymers consisting of siloxane units represented by the general formula: R′₂HSiO_{1/2} and siloxane units represented by the formula: R′SiO_{3/2}; organopolysiloxane copolymers consisting of siloxane units represented by the general formula: R′HSiO_{2/2}, siloxane units represented by the general formula: R′SiO_{3/2}, or siloxane units represented by the formula: HSiO_{3/2}; and mixtures of two or more types of these organopolysiloxanes. Note that R′ in the formulas is an alkyl group having a carbon number of from 1 to 8, an aryl group, an aralkyl group, or a halogenated alkyl group, with examples thereof being the same as those described above.

Specific examples of component (C) include tris(dimethylhydrogensiloxy)methylsilane, tetra(dimethylhydrogensiloxy)silane, methylhydrogenpolysiloxanes capped at both terminals with trimethylsiloxy groups, dimethylsiloxane/methylhydrogensiloxane copolymers capped at both terminals with trimethylsiloxy groups, dimethylsiloxane/methylhydrogensiloxane copolymers capped at both terminals with dimethylhydrogensiloxy groups, cyclic methylhydrogen oligosiloxanes, cyclic methylhydrogensiloxane/dimethylsiloxane copolymers, methylhydrogensiloxane/diphenylsiloxane copolymers capped at both molecular terminals with trimethylsiloxy groups, methylhydrogensiloxane/diphenylsiloxane/dimethylsiloxane copolymers capped at both molecular terminals with trimethylsiloxy groups, hydrolytic condensates of trimethylsilanes, copolymers consisting of (CH₃)₂HSiO_{1/2} units and SiO_{4/2} units, copolymers consisting of (CH₃)₂HSiO_{1/2} units, SiO_{4/2} units, and (C₆H₅)SiO_{3/2} units, copolymers consisting of (CH₃)₂HSiO_{1/2} units and CH₃SiO_{3/2} units, and mixtures of two or more types thereof.

In the case of a straight-chain structure, in particular, a methylhydrogenpolysiloxane represented by the molecular structural formula: RTMe₂SiO(Me₂SiO)_{q}(HMeSiO)ₜSiMe₂RT (wherein, Me is a methyl group, RT is a methyl group or a hydrogen atom, and q and r are numbers satisfying 0.3≤r/(q+r)≤1 and 5≤(q+r)≤200) is preferable. Note that component (C) may use two or more different types in combination.

Similarly, the following organosiloxanes may be given as examples. Note that in the formulas, Me and Ph respectively represent a methyl group and a phenyl group, m is an integer from 1 to 100, n is an integer from 1 to 50, and b, c, d, and e are each positive numbers, where the sum of b, c, d, and e in one molecule is 1.

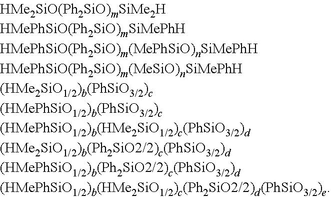

### [SiH/Vi Ratio]

The composition according to the present invention is hydrosilylation reaction curable and the usage amount of component (C) is not particularly limited as long as the composition can sufficiently cure via a hydrosilylation reaction. However, the amount of silicon atom-bonded hydrogen atom (SiH) groups in component (C) with respect to the sum of the amount (substance amount) of alkenyl groups in component (A) and the amount (substance amount) of alkenyl groups in component (B) in the composition, that is, the molar ratio, is preferably within a range of 7 to 300, 7 to 200, 7 to 100; and may be within a range of 7 to 60, within a range of 7 to 50, or within a range of 7 to 40.

In contrast, in order to improve adhesion to a substrate of glass, etc., the number of SiH groups per molecule can be designed to be 10 or more and 20 or more, is preferably more than 20, and more preferably 22 or more. For example, the substance amount of silicon atom-bonded hydrogen atoms (SiH) groups in component (C) with respect to the sum of the amount (substance amount) of alkenyl groups in component (A) and the amount (substance amount) of alkenyl groups in component (B) in the composition can be designed so as to be in a range of 10 to 60 and a range of 10 to 50. When the amount of the SiH groups falls below the abovementioned lower limit, the technical effect of improving adhesion to the substrate may not be achieved. In contrast, when the amount of the SiH groups exceeds the abovementioned upper limit, the amount of unreacted residual curing agent becomes large, which may have adverse effects on curing physical properties such as the brittleness of the cured product or may cause problems such as gas generation. However, a pressure sensitive adhesive layer can be formed which is sufficient for practical use even when the SiH/Vi ratio of the composition is outside the abovementioned range.

### [Hydrosilylation Reaction Catalyst]

The organopolysiloxane composition of the present invention contains a hydrosilylation reaction catalyst. Examples of hydrosilylation reaction catalysts include platinum-based catalysts, rhodium-based catalysts, and palladium-based catalysts, with platinum-based catalysts preferable in that they markedly accelerate the curing of the present composition. Examples of this platinum based catalyst include platinum fine powder, chloroplatinic acid, an alcohol solution of chloroplatinic acid, a platinum-alkenyl siloxane complex, a platinum-olefin complex, and a platinum-carbonyl complex, with a platinum-alkenyl siloxane complex particularly preferable. Examples of this alkenyl siloxane include 1,3-divinyl-1,1,3,3-tetramethyldisiloxane, 1,3,5,7-tetramethyl-1,3,5,7-tetravinylcyclotetrasiloxane, alkenyl siloxanes in which some of the methyl groups of these alkenyl siloxanes are substituted with groups selected from the group consisting of nitriles, amides, dioxolanes, sulfolanes, ethyl groups, phenyl groups, or the like, and alkenyl siloxanes in which the vinyl groups of these alkenyl siloxanes are substituted with allyl groups, hexenyl groups, or the like. In particular, 1,3-divinyl-1,1,3,3-tetramethyldisiloxane is preferable because the platinum-alkenyl siloxane complex has good stability. As the catalyst for promoting the hydrosilylation reaction, a non-platinum based metal catalyst such as iron, ruthenium, iron/cobalt, or the like may be used.

While the content of the hydrosilylation reaction catalyst is not particularly limited thereto in the present invention, the amount of the platinum based metal with respect to the total amount of solids in the composition (i.e. excluding solvents) is within a range of 0.1 to 200 ppm, and may be within a range of 0.1 to 150 ppm, within a range of 0.1 to 100 ppm, or within a range of 0.1 to 50 ppm. Here, the platinum-based metal is a metal element of group VIII consisting of platinum, rhodium, palladium, ruthenium, and iridium; however, in practical use, the content of the platinum metal excluding the ligands of the hydrosilylation catalyst is preferably within the range described above. Note that the solid content is a component that forms the cured layer (primarily a main agent, an adhesion-imparting component, a crosslinking agent, a catalyst, and other non-volatile components) when the organopolysiloxane composition of the present invention is subjected to a curing reaction and does not include volatile components such as solvents that volatilize at the time of heat curing.

When the content of the platinum based metal in the organopolysiloxane composition according to the present invention is 60 ppm or less, 50 ppm or less, 35 ppm or less, 30 ppm or less, 25 ppm or less, or 20 ppm or less, this may suppress discoloration or coloration of the transparent pressure sensitive adhesive layer, in particular, after curing or when heated or exposed to high energy rays such as UV rays. Meanwhile, from the perspective of the curability of the organopolysiloxane composition, the content of the platinum-based metal is not lower than 0.1 ppm, as when the content is lower than this lower limit, this may cause curing defects.

### [Component (D) as Anchorage Additive]

Component (D) is at least one tetraalkoxysilane or a prepolymer of the tetraalkoxysilane which is an anchorage additive of the silicone-based PSA composition of the present invention to improve adhesion force without affecting its rheological/viscoelastic properties for the silicone-based pressure sensitive adhesive layer. Although rheological/viscoelastic properties in cured silicone PSA layer is generally determined by its cross-linking polymer structure (including polymeric chain length), resinous structures (including silicone-resin units and Mw) and molar ratio therein resulting in trade-off relationship between lower Tg or modulus and higher adhesion force, in this invention, only adhesion force can be increased without affecting lower Tg or modulus properties in cured silicone PSA layer by using tetraalkoxysilane or a prepolymer of the tetraalkoxysilane as anchorage additive.

In preferred embodiment of this invention, the adhesive force of a pressure sensitive adhesive layer having a thickness of 50 μm obtained by curing the composition, as measured at a tensile speed of 300 mm/min using a 180° peeling test method according to JIS Z 0237 for glass substrate is more than 20% greater than, preferably 30% to 80% greater than that for the pressure sensitive adhesive layer obtained from the same composition but lacking component (D). Furthermore, as measured by the same method, the adhesive force of a pressure sensitive adhesive layer can be within a range of 800 to 3000 gf/inch, preferably be within a range of 800 to 2000 gf/inch, more preferably be within a range of 800 to 1500 gf/inch, with lower Tg or modulus.

To achieve the greater adhesive force, component (D) is required to be at least one tetraalkoxysilane or a prepolymer of the tetraalkoxysilane, which is exemplified by tetramethoxysilane, tetraethoxysilane or mixture thereof. As prepolymer of the tetraalkoxysilane, fully or partially condensation reaction product of said tetraalkoxysilane is exemplified. Using other silanes like glycidoxypropyltrimethoxysilane or vinyltrimethoxysilane in replacement of said tetraalkoxysilane cannot improve or enhance the adhesive force without affecting its rheological/viscoelastic properties for the silicone-based pressure sensitive adhesive layer. Furthermore, to achieve sufficient improvement in the adhesive force, the amount of component (D) based on total mass of components (A) to (C) is within a range of 0.1 to 9.0 mass %, preferably within a range of 0.2 to 7.0 mass %, more preferably within a range of 0.5 to 5.0 mass % assuming the mass ratio of component (B) to component (A) is within a range of 0.5 to 3.5. When the amount of the component (D) falls below the abovementioned lower limit, the technical effect of improving adhesion to the substrate may not be sufficiently achieved. In contrast, when the amount of component (D) exceeds the abovementioned upper limit, excess amount of component (D) may have adverse effects on curing physical properties.

In this Invention, component (F) is a curing retarder (=curing inhibitor) and is compounded in order to suppress crosslinking reactions between the alkenyl groups in the composition and the SiH groups in component (C) so as to extend the usable life at ordinary temperatures and enhance the storage stability. Accordingly, in practical use, the component (F) may be added to the pressure sensitive adhesive layer-forming organopolysiloxane composition according to the present invention.

Specific examples of component (F) include acetylenic compounds, eneyne compounds, organic nitrogen compounds, organic phosphorus compounds, and oxime compounds. Specific examples include: alkyne alcohols such as 3-methyl-1-butyne-3-ol, 3,5-dimethyl-1-hexyne-3-ol, 3-methyl-1-pentyne-3-ol, 1-ethynyl-1-cyclohexanol, phenyl butanol, and the like; eneyne compounds such as 3-methyl-3-pentene-1-yne, 3,5-dimethyl-1-hexyne-3-yne, and the like; methylalkenylcyclosiloxanes such as 2-ethynyl-4-methyl-2-pentene, 1,3,5,7-tetramethyl-1,3,5,7-tetravinylcyclotetrasiloxane, 1,3,5,7-tetramethyl-1,3,5,7-tetrahexenylcyclotetrasiloxane, and the like, as well as benzotriazoles.

From the perspective of the curing behavior of the composition, the pressure sensitive adhesive layer-forming organopolysiloxane composition of the present invention is preferably curable at 80 to 200° C. with an increase in viscosity within 1.5-fold after 8 hours at room temperature following the preparation of the composition. The suppression of thickening is important from the perspective of handleability, pot life, and characteristics after curing and contains a large excess of component (C), wherein, even if the content of the platinum-based metal is optionally low, the curability can be ensured by curing at high temperature of at least a certain temperature (80 to 200° C.). Note that such a composition can be realized by selecting a suitable combination and compounded amounts of each of the components described above, the hydrosilylation catalyst, and component (F).

In addition to the preferred components (A) and (B) described above, the organopolysiloxane composition of the present invention may also contain an organic solvent as a solvent. The type and blending amount of the organic solvent can be adjusted taking the coating workability, etc. into consideration. Exemplary organic solvents include: aromatic hydrocarbon-based solvents such as toluene, xylene and benzene; aliphatic hydrocarbon-based solvents such as heptane, hexane, octane and isoparaffin; ester-based solvents such as ethyl acetate and isobutyl acetate; ether-based solvents such as diisopropyl ether and 1,4-dioxane; chlorinated aliphatic hydrocarbon-based solvents such as trichloroethylene, perchloroethylene and methylene chloride; and solvent volatile oils; with two or more types capable of being combined in accordance with the wettability of the sheet-like substrate or the like. The compounded amount of the organic solvent is preferably an amount such that a mixture of components (A) to (C) can be uniformly applied to a sheet-like substrate surface. For example, the compounded amount may be from 5 to 3000 parts by mass per total amount of 100 parts by mass of components (A), (B) and (C).

The organopolysiloxane composition of the present invention may optionally contain components other than the components described above to such an extent that does not impair the technical effects of the present invention. For example, the composition may contain: an adhesion promoter; a non-reactive organopolysiloxane such as a polydimethylsiloxane or a polydimethyldiphenylsiloxane; an antioxidant such as a phenol-type, a quinone-type, an amine-type, a phosphorus-type, a phosphite-type, a sulfur-type or a thioether-type antioxidant; a flame retardant such as a phosphate ester-type, a halogen-type, a phosphorus-type or an antimony-type flame retardant; and one or more types of antistatic agents consisting of a cationic surfactant, an anionic surfactant, a non-ionic surfactant or the like. Note that, in addition to these components, pigments, dyes, inorganic microparticles (e.g., reinforcing fillers, dielectric fillers, conductive fillers, thermally conductive fillers), etc. can be optionally blended.

[(A′) Linear Organopolysiloxane which does not Contain a Carbon-Carbon Double Bond-Containing Reactive Group in the Molecule]

The organopolysiloxane composition according to the present invention can comprise a non-reactive organopolysiloxane such as a polydimethylsiloxane or polydimethyldiphenylsiloxane that does not contain a carbon-carbon double bond-containing reactive group such as an alkenyl group, acryl group or methacryl group. As a result, it may be possible to improve the loss coefficient (tan δ), storage elastic modulus (G′), loss modulus (G″) and adhesion of the pressure sensitive adhesive layer. For example, the loss coefficient of the pressure sensitive adhesive layer can be increased using a polydimethyl siloxane having a hydroxyl group terminal, or a polydimethylsiloxane or polydimethyldiphenylsiloxane having a trimethylsiloxy terminal, with such compositions included within the scope of the present invention.

Preferably, component (A′) is (A′1) a raw rubber-like organopolysiloxane having a viscosity of 100,000 mPa·s or more at 25° C. or having a plasticity number within a range of 50 to 200 as measured in accordance with a method as described in JIS K6249.

In most preferable embodiment of this invention, assuming the use of component (D) as anchorage additive to improve the adhesive force in the cured PSA layer, both component (A) and (A′) are raw rubber-like organopolysiloxanes having higher viscosity or plasticity number in 50 to 100 mass %. Specifically, in the preferred embodiment of this invention, 50 to 100 mass % of said component (A) is (A1) a raw rubber-like alkenyl group-containing organopolysiloxane having a viscosity of 100,000 mPa·s or more at 25° C. or having a plasticity number within a range of 50 to 200 as measured in accordance with a method as described in JIS K6249, and the content of a vinyl (CH2=CH—) moiety of alkenyl group is within a range of 0.005 to 0.400 mass %; 50 to 100 mass % of said optional component (A′) is (A′1) a raw rubber-like organopolysiloxane having a viscosity of 100,000 mPa·s or more at 25° C. or having a plasticity number within a range of 50 to 200 as measured in accordance with a method as described in JIS K6249; and the mass ratio of component (A) to component (A′) ranges from 100:0 to 40:60 in the composition.

The method of preparing the silicone-based PSA-forming composition is not particularly limited and is performed by homogeneously mixing the respective components. A solvent may be added as necessary and the composition may be prepared by mixing at a temperature of from 0 to 200° C. using a known stirrer or kneader.

### [Forming Adhesive Layer Using Said Silicone-Based PSA-Forming Composition]

Aforementioned silicone-based PSA-forming composition forms a cured adhesive layer when applied to a substrate and forms a cured product by heating under temperature conditions of from 80 to 200° C., preferably under temperature conditions of from 90 to 190° C. Examples of application methods include gravure coating, offset coating, offset gravure, roll coating, reverse roll coating, air knife coating, curtain coating and comma coating.

The cured adhesive layer from said silicone-based PSA-forming composition is arranged between the functional layers to bond/assemble the layers in the electronic article of this invention.

### [Storage Elastic Modulus and Other Viscoelasticity]

Aforementioned silicone-based PSA-forming composition according to the present invention has a shear storage elastic modulus G′ at −20° C. of a pressure sensitive adhesive layer (obtained by curing) within a range of 0.01 to 2.0 MPa, the storage elastic modulus G′ may be within a range of 0.02 to 1.5 MPa and within a range of 0.03 to 1.2 MPa, with those within a range of 0.04 to 1.0 MPa also being suitably included in the scope of the present invention. The pressure sensitive adhesive layer-forming organopolysiloxane composition according to the present invention, which has a relatively low storage elastic modulus G′ at low temperatures and the abovementioned practical adhesive force, is suitable as a member of an electronic device or an electrical device (such as a speaker or transducer) and suitable for applications in the field of advanced electronics materials and display elements such as smart devices, in order to form an elastic adhesive member.

The storage elastic modulus (G′) of the pressure sensitive adhesive layer according to the present invention can be measured via a known measurement method. For example, measurements can be carried out using a storage elastic modulus (G′) MCR301 viscoelastic measurement device (available from Anton Paar). Using a disk shaped sample having a diameter of approximately 8 mm and a thickness of approximately 0.5 to 1 mm, the value can be measured as a value at −20° C. within a range of −40° C. to 100° C., which is the use temperature, utilizing an 8 mm parallel plate, at a frequency of 1 Hz, a strain of 0.1%, and a temperature rising rate of 3° C./minute.

The pressure sensitive adhesive layer according to the present invention may have a storage elastic modulus G′ at 1.0 Hz at −20° C. which is no less than three-fold the storage elastic modulus G′ at 1.0 Hz at 25° C.

### [Properties Relating to Transparency, Color Tone, or Coloration and Discoloration of the Pressure Sensitive Adhesive Layer]

Aforementioned silicone-based PSA layer of the present invention may be substantially transparent, translucent or opaque, such that the transparency thereof can be designed in accordance with the application of said interlayer adhesive layer. For example, as an interlayer pressure sensitive adhesive layer applied for a display device of present invention, a film-like cured product with a thickness of from 10 to 1000 μm obtained by curing said silicone-based PSA-forming composition is preferably visually transparent and preferably does not contain a coloring additive such as carbon black. Note that when it is visually transparent, or more objectively, when the value for air is 100%, the transmittance of light at a wavelength of 450 nm of the pressure sensitive adhesive layer for a display device formed from a cured layer having a thickness of 100 μm is 80% or higher and suitably 90% or higher and may be designed to be 95% or higher. In contrast, in the adhesion, etc. of an electrical or electronic part which does not require light transmittance, a semi-transparent to opaque pressure sensitive adhesive layer may be used, with a filler component or additive which impairs colorability or light transmittance capable of being used depending on the required characteristics other than light transmittance.

Said adhesive layer can be designed such that the cured product is not colored, in addition to the abovementioned transparency, by optionally reducing the content of the platinum based metal in the cured layer. Specifically, the b* value, which is measured with the L*a*b* color system as prescribed in JIS Z 8729, immediately after curing a cured layer having a thickness of 100 μm obtained by curing the organopolysiloxane composition of the present invention, can be designed so as to be no greater than 0.15 and no greater than 0.10. Having such b* values means that the cured layer is substantially transparent and not yellow colored.

Even when the cured layer of the present invention is exposed to high temperatures or high-energy beams such as UV rays for an extended period of time, it can be designed such that the color tone thereof does not significantly change and the problem of yellowing, in particular, does not occur. Specifically, even if any of the following evaluations are made, the change (Δb*) in the b* value measured with the L*a*b* color system as prescribed in JIS Z 8729 immediately after evaluation, for a cured layer having a thickness of 100 μm obtained by curing the organopolysiloxane composition of the present invention, can be designed so as to be no greater than 0.20 and preferably no greater than 0.15. Note that Δb* is an absolute value of the numerical change.

(1) Thermal aging evaluation: The cured layer is aged for 300 hours at 105° C.
(2) High-energy beam irradiation: A sample of the cured layer is irradiated for 75 hours at room temperature with UV light using a mercury lamp (for example, Optical Module X or the like manufactured by Ushio Electric Co., Ltd.) having an intensity of 12 mW/cm² at 365 nm and an intensity of 3.5 mW/cm² at 254 nm.

### [Use as a Pressure Sensitive Adhesive Layer]

The cured product of the present invention can, in particular, be used as a pressure sensitive adhesive layer. In addition, in order to improve adhesion with the adherend, surface treatment such as primer treatment, corona treatment, etching treatment, or plasma treatment may be performed on the surface of the pressure sensitive adhesive layer or the substrate. However, because the pressure sensitive adhesive layer according to the present invention has excellent adhesion to a substrate of a display device, etc. as described above, these steps may be added, as required, to further improve the adhesion with the adherend, with a higher production efficiency capable of being achieved by eliminating these steps.

The curable organopolysiloxane composition of the present invention is cured after applying the composition onto a release liner, heating under the temperature conditions described above, then, after the release liner is peeled off and the composition is attached to a film-like substrate, a tape-like substrate, or a sheet-like substrate (called a “film-like substrate” hereinafter) or applied onto a film-like substrate, curing by heating at the temperature conditions described above so as to form a pressure sensitive adhesive layer on the surface of the substrate. A laminate provided with a cured layer—in particular, a film-like pressure sensitive adhesive layer—obtained by curing the organopolysiloxane composition of the present invention on these film-like substrates, may be used for adhesive tapes, adhesive bandages, low-temperature supports, transfer films, labels, emblems, and decorative or explanatory signs. Further, a cured layer obtained by curing the organopolysiloxane composition of the present invention may be used to assemble automobile parts, toys, electronic circuits, or keyboards. Alternatively, a cured layer formed by curing the organopolysiloxane composition of the present invention, and particularly a film-like pressure sensitive adhesive layer, may be used in the construction and use of a laminated touch screen or flat panel display.

Exemplary types of substrates include: paperboard; cardboard paper; clay-coated papers; polyolefin laminate papers, particularly polyethylene laminate papers; synthetic resin films and sheets; natural fiber woven materials; synthetic fiber woven materials; artificial leather woven materials; and metal foils. In particular, synthetic resin films and sheets are preferable, with examples of synthetic resins including polyimides, polyethylenes, polypropylenes, polystyrenes, polyvinyl chlorides, polyvinylidene chlorides, polycarbonates, polyethylene terephthalates, cyclopolyolefins, and nylons. When heat resistance is required, a heat resistant synthetic resin film such as a polyimide, polyetheretherketone, polyethylene naphthalate (PEN), liquid crystal polyacrylate, polyamide-imide, polyether sulfone, and the like is particularly preferable. Meanwhile, for applications such as a display device in which visibility is required, a transparent substrate and specifically a transparent material such as a polypropylene, polystyrene, polyvinylidene chloride, polycarbonate, polyethylene terephthalate, and the like is preferable.

The substrate is preferably a film-like or a sheet-like substrate. The thickness thereof is not particularly limited and can be designed with a desired thickness in accordance with the application. Furthermore, in order to improve the adhesion between a supporting film and pressure sensitive adhesive layer, a supporting film subjected to a primer treatment, corona treatment, etching treatment, or plasma treatment may be used. Furthermore, the opposite surface of the film-like substrate from the pressure sensitive adhesive layer surface may be subjected to a surface treatment such as a treatment for scratch prevention, grime prevention, fingerprint adhesion prevention, anti-glare, anti-reflection, anti-static, or other treatment.

As to the application methods to the substrate, gravure coating, offset coating, offset gravure, roll coating using an offset transfer roll coater, reverse roll coating, air knife coating, curtain coating using a curtain flow coater or the like, comma coating, Meyer bar, or another known method used for the purpose of forming a cured layer may be used without limitation.

The coating amount can be designed at a desired thickness in accordance with the application such as a display device, as one example, the thickness of the pressure sensitive adhesive layer after curing may be from 1 to 1000 μm, from 5 to 900 μm, or from 10 to 800 μm; however, there is no limitation thereto.

The pressure sensitive adhesive layer according to the present invention may be a single layer or a multilayer structure obtained by laminating two or more pressure sensitive adhesive layers, in accordance with the required characteristics. Multiple pressure sensitive adhesive layer may be formed by bonding the pressure sensitive adhesive films (which are formed film by film) thereto, or the step of applying and curing the pressure sensitive adhesive layer-forming organopolysiloxane composition may be carried out multiple times on a film substrate (including a release layer), etc.

The pressure sensitive adhesive layer according to the present invention may serve as other functional layers selected from a dielectric layer, conductive layer, heat dissipation layer, insulating layer, reinforcing layer, etc., in addition to adhering or sticking functions between members. Also, as interlayer silicone-based PSA layer, in addition to adhering or sticking functions between members, the silicone-based PSA layer of this invention can be applied as a damping/shock-absorption layer.

Preferably, since said interlayer adhesive layer have both assembly/bonding layer function and damping/shock-absorption layer function, the electronic article having the silicone-based PSA layer of this invention need not have further interlayer damping/shock-absorption layer arranged between two functional layers. For this bifunctional feature of said interlayer adhesive layer, through this invention, the electronic article can be constructed without using other interlayer damping/shock-absorption layers other than the interlayer adhesive layer according to the present invention between two functional layers.

In one preferred embodiment, the electronic article having the silicone-based PSA layer of this invention as its interlayer adhesive layer is LED or OLED type display devices and its module thereof having a structure that transparent displaying unit is directly bonded or assembled to other functional unit with said interlayer adhesive layer, wherein the interlayer adhesive layer is a single adhesive/assembly layer sandwiched between said units in the display device. Since the display devices having the silicone-based PSA layer can be designed to be substantively free from additional interlayer damping/shock-absorption layer except for said interlayer adhesive layer of the present invention (i.e. omitting thick and multi-layered damping/shock-absorption layer from the devices), the overall thickness of said display can be thinner and lighter in comparison with conventional devices.

When the cured layer obtained by curing the organopolysiloxane composition of the present invention is a pressure sensitive adhesive layer, in particular, a pressure sensitive adhesive layer, the cured layer is preferably treated as a laminate film that is peelably adhered to a film substrate provided with a release layer having a release-coating capability. The release layer may also be referred to as a release liner, a separator, a release layer, or a release coating layer, and may preferably be a release layer having a release coating ability such as a silicone-based release agent, a fluorine-based release agent, an alkyd-based release agent, or a fluorosilicone-based release agent, or the release layer may be formed as a substrate itself which is not prone to adhering to the resin sheet for a pressure sensitive adhesive layer of the present invention by forming physically fine irregularities in the surface of the substrate. In particular, in the laminated body according to the present invention, a release layer obtained by curing a fluorosilicone release agent is preferably used as the release layer.

The cured product obtained by curing the organopolysiloxane composition according to the present invention has both viscoelasticity and adhesive strength as described above, making it useful as a member of various types of electronic equipment or electrical devices as elastic adhesive members. In particular, it is useful as an electronic material, a member for a display device, or a member for a transducer (including sensors, speakers, actuators, and generators), with a suitable application for the cured product being a member for an electronic part or a display device. The cured product according to the present invention may be transparent or opaque, wherein, in particular, a film-shaped cured product, particularly a substantially transparent pressure sensitive adhesive film, is suitable as a member for a display panel or a display, and is particularly useful in so-called touch panel applications in which a device, particularly an electronic device, can be operated by touching a screen with a fingertip or the like. Moreover, the opaque elastic adhesive layer is not required to have transparency, making it particularly useful for applications of film-like or sheet-like members used in sensors, speakers, actuators, etc. which require constant elasticity or flexibility in the adhesive layer itself.

In particular, the pressure sensitive adhesive layer obtained by curing the organopolysiloxane composition according to the present invention is capable of achieving a pressure sensitive adhesive characteristic equivalent to conventional silicone pressure sensitive adhesive layers and can improve adhesion to the substrate of a display device, etc. without causing problems of poor curing or reduced curability.

### [Member for Display Panel or Display]

A cured product obtained by curing the organopolysiloxane composition of the present invention can be used in the construction and use of a laminated touch screen or flat panel display, with the specific method of use thereof capable of being a known method of use of a pressure sensitive adhesive layer (in particular, silicone PSA) without any particular limitation.

For example, a cured product obtained by curing the organopolysiloxane composition of the present invention can be used in the production of a display device such as a touch panel as an optically transparent silicone-based pressure sensitive adhesive film or an adhesive layer disclosed in JP 2014-522436 W or JP 2013-512326 W described above. Specifically, the cured product obtained by curing the organopolysiloxane composition of the present invention can be used as the adhesive layer or adhesive film described in JP 2013-512326 W without any particular limitation.

As an example, the touch panel according to the present invention may be a touch panel including a substrate such as a conductive plastic film having a conductive layer formed on one surface and a cured layer obtained by curing the curable organopolysiloxane composition of the present invention, which is attached to a surface on the side in which the conductive layer is formed or on the opposite side thereof. The substrate is preferably a sheet-like or film-like substrate, with examples thereof including a resin film or a glass plate. In addition, the conductive plastic film may be a resin film or a glass plate, in particular, a polyethylene terephthalate film, having an ITO layer formed on one surface thereof. These are disclosed in JP 2013-512326 W and the like described above.

In addition, a cured product obtained by curing the organopolysiloxane composition of the present invention may be used as an adhesive film for a polarizing plate used in the production of a display device such as a touch panel, or may be used as a pressure sensitive adhesive layer used in bonding between a touch panel and a display module described in Japanese Unexamined Patent Application Publication No. 2013-065009.

### INDUSTRIAL APPLICABILITY

Applications of the silicone-based pressure sensitive adhesive layer-forming composition and a cured product obtained by curing the same according to the present invention are in no way limited to the disclosure above, with a pressure sensitive adhesive film provided with a cured product obtained by curing the composition capable of being used in various display devices for displaying characters, symbols, and images such as television receivers, computer monitors, monitors for personal digital assistants, monitoring monitors, video cameras, digital cameras, mobile phones, personal digital assistants, displays for instrument panels of automobiles or the like, displays for instrument panels of various equipment, devices, and instruments, automatic ticket machines, automated teller machines, on-board display devices, and on-board transmission screens. The surface shape of such a display device may be a curved shape or a bowed shape rather than a flat surface, with examples thereof including curved displays or curved transmission screens used in automobiles (including electric vehicles), aircraft, or the like in addition to various flat panel displays (FPDs). Further, these display devices can display icons for executing functions or programs on a screen or display, notification indicators of e-mail, programs, or the like, and operation buttons for various devices such as car navigation devices, membranes for speakers, audio devices, and air conditioning devices, with touch panel functions enabling input operations capable of being added by touching these icons, notification indicators, or operation buttons with a finger. Application is possible as a device for CRT displays, liquid crystal displays, plasma displays, organic electroluminescent (EL) displays, inorganic EL displays, LED displays, surface electrolytic displays (SEDs), field emitting displays (FEDs), and other displaying devices, or touch panels using the displaying devices. Moreover, the cured product obtained by curing the composition has excellent adhesion and viscoelastic characteristics, allowing it to be used as a film-like or sheet-like member which is a member for transducers (including a sensor, speaker, actuator, etc.) in addition to being capable of being used as a sealing layer or adhesive layer used in a secondary battery, fuel cell, or solar cell module.

A pressure sensitive adhesive layer obtained by curing the silicone-based pressure sensitive adhesive layer-forming composition according to the present invention may be substantially transparent and does not cause problems such as poor curing or reduced curability, in addition to having excellent adhesion to substrates of various display devices, etc. Therefore, the pressure sensitive adhesive layer can be suitably used in a vehicle display device with good visibility and operability of the display content over an extended period of time, and in particular, a vehicle display device having a curved screen or a curved display and optionally equipped with a touch panel function. For example, vehicle display devices equipped with curved display surfaces are disclosed in Japanese Unexamined Patent Application Publication No. 2017-047767, Japanese Unexamined Patent Application Publication No. 2014-182335, Japanese Unexamined Patent Application Publication No. 2014-063064, Japanese Unexamined Patent Application Publication No. 2013-233852, and the like; however, the pressure sensitive adhesive layer of the present invention can be suitably applied or replaced as part or all of an adhesive layer or a pressure sensitive adhesive layer for which transparency is required in these documents. Further, it goes without saying that regarding the pressure sensitive adhesive layer-forming organopolysiloxane composition according to the present invention, currently used adhesive layers or pressure sensitive adhesive layers requiring transparency may be used as a substitute for other known curved display devices as well, and in order to further leverage the advantages of the pressure sensitive adhesive of the present invention, it is preferable to adjust the design of the display device or the thickness of the member using known techniques.

Note that a transparent film-like substrate provided with the pressure sensitive adhesive layer of the present invention may be used for the purpose of scratch prevention, stain prevention, fingerprint adhesion prevention, static prevention, glare prevention, peep prevention, and the like of these display surfaces.

### EXAMPLES

These examples are intended to illustrate the invention to one skilled in the art and are not to be interpreted as limiting the scope of the invention set forth in the claims. Note that “cured” in each of the examples, comparative examples, and reference examples means that each composition has fully cured under the respective curing conditions.

The materials in Table 1 were used in these examples. The materials of the curing reactive organopolysiloxane compositions are shown in Table 2. Note that the viscosity and plasticity number of each component was measured at room temperature using the following method.

### (Viscosity)

The viscosity (mPa·s) is a value measured using a rotary viscometer conforming to JIS K7117-1, while the kinematic viscosity (mm²/s) is a value measured with an Ubbelohde viscometer conforming to JIS Z8803).

### (Plasticity Number)

The plasticity number was expressed as a value measured in accordance with the method prescribed in JIS K 6249 (the thickness when a 1 kgf load was applied for 3 minutes to a 4.2 g spherical sample at 25° C. was read up to 1/100 mm, and this value was multiplied by 100).

TABLE 1
Components of the silicone-based PSA-forming composition

| Component | Description |
|---|---|
| (A) | Vinyl-functional polydimethylsiloxane gum, plasticity |
| | number of 152, vinyl content of 0.013 wt % |
| (A′) | Methyl-terminated high molecular weight |
| | polydimethylsiloxane, plasticity number of 170 |
| (B) | Trimethylsilyl-capped MQ resin, with OH content of |
| | 0.89 wt %, Mw being 5400, Mn being 2900, non- |
| | volatile content of 70% |
| (C) | Poly(dimetylsiloxane-co-methylhydrogen)siloxane, |
| | trimethylsilyl-end-capped, with H content of 0.76 wt % |
| (D) | Tetraethoxysilane (as anchorage additive) |
| (E) | Platinum-based catalyst containing 0.62 wt % Pt metal |
| (F) | 1-ethyny1-1-cyclohexanol (Etch) |
| (G) | Toluene |

### [Preparation of Silicone-Based PSA-Forming Composition]

The silicone-based PSA-forming described in each of the examples, comparative examples and reference examples were prepared using the components shown in Table 1. Also, formulations and adhesive forces of working examples, comparative examples and reference examples are summarized in Table 2.

### (Measurement of the Molecular Weight of the Organopolysiloxane Component)

Using gel permeation chromatography (GPC) available from Waters and tetrahydrofuran (THF) as a solvent, the weight average molecular weight (Mw) and number average molecular weight (Mn) of organopolysiloxane components such as organopolysiloxane resin were determined in terms of standard polystyrene.

### (Measurement of the Content of Hydroxyl Groups (OH) in Organopolysiloxane Resin)

Using an ACP-30029 Si NMR spectrometer available from Bruker equipped with a glass-free probe, when the chemical shift of the tetramethylsilane was set to 0 ppm, the molar content was obtained from the presence ratio of Si(OH)O_{2/3} units appearing at −93 to −103.5 ppm to all silicon atoms, then further converted into the mass % of the hydroxyl groups (OH) in the organopolysiloxane resin. Note that hydrolyzable groups other than hydroxyl groups were not included in the organopolysiloxane resin in the following examples.

### (Adhesive Force Measurement)

Each composition was applied to a PET film (available from Toray Co., Ltd., product name: Lumirror (registered trademark) S10, thickness: 50 μm) such that the thickness after curing was 50 μm, after which it was cured for 3 minutes at 150° C. After being allowed to stand for one day, the sample was cut to a width of 20 mm and the adhesive layer surface was affixed to a glass slide (provided by Sinopharm Chemical Reagent Co., Ltd, 25.4×76.2×2.0 mm) or a polymethyl methacrylate (PMMA) plate (manufactured by Paltec, ACRYLITE L001, 50×120×2 mm) using a roller to form a test piece and was kept at room temperature for 30 minutes. Regarding the test piece using the glass or PMMA plate, the adhesive force (measurement at a width of 20 mm converted to the display unit gf/inch) was measured at a tensile speed of 300 mm/min using the 180° peeling test method in accordance with JIS Z 0237, using an RTC-1210 tensile tester manufactured by Orientec Co., Ltd.

### Comparative Example 1

18.64 parts by weight of the vinyl functional polydimethylsiloxane of component A,
4.66 parts by weight of the methyl-terminated high molecular weight polydimethylsiloxane of component A′,
40.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 33.

The composition was cured via the abovementioned method, after which the adhesive force on the glass slides were measured via the abovementioned method, the evaluation results, etc. of which were indicated in Table 2.

### Comparative Example 2

16.31 parts by weight of the vinyl functional polydimethylsiloxane of component A,
6.99 parts by weight of the methyl-terminated high molecular weight polydimethylsiloxane of component A′,
45.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 37.

The composition was cured via the abovementioned method, after which the adhesive force on the glass slides were measured via the abovementioned method, the evaluation results, etc. of which were indicated in Table 2.

### Comparative Example 3

13.98 parts by weight of the vinyl functional polydimethylsiloxane of component A,
9.32 parts by weight of the methyl-terminated high molecular weight polydimethylsiloxane of component A′,
45.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 44.

The composition was cured via the abovementioned method, after which the adhesive force on the glass slides were measured via the abovementioned method, the evaluation results, etc. of which were indicated in Table 2.

### Comparative Example 4

11.65 parts by weight of the vinyl functional polydimethylsiloxane of component A,
11.65 parts by weight of the methyl-terminated high molecular weight polydimethylsiloxane of component A′,
45.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 52.

The composition was cured via the abovementioned method, after which the adhesive force on the glass slides were measured via the abovementioned method, the evaluation results, etc. of which were indicated in Table 2.

### Comparative Example 5

16.31 parts by weight of the vinyl functional polydimethylsiloxane of component A,
6.99 parts by weight of the methyl-terminated high molecular weight polydimethylsiloxane of component A′,
65.37 parts by weight of the Trimethylsilyl-capped MQ resin of component B,
23.30 parts by weight of toluene of component G,
0.053 parts by weight of Poly(dimethylsiloxane-co-methylhydrogen)siloxane, trimethylsilyl-end-capped of component C,
0.06 parts by weight of 1-ethynyl-1-cyclohexanol of component F,
were sufficiently mixed at room temperature,
after which 0.25 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 5.0.

The composition was cured via the abovementioned method, after which the adhesive force on the PMMA plates were measured via the abovementioned method, the evaluation results, etc. of which were indicated in Table 2.

### Example 1

18.64 parts by weight of the vinyl functional polydimethylsiloxane of component A,
4.66 parts by weight of the methyl-terminated high molecular weight polydimethylsiloxane of component A′,
40.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
1.0 parts by weight of Tetraethoxysilane of component D,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 33.

The composition was cured via the abovementioned method, after which the adhesive force on the glass slides were measured via the abovementioned method, the evaluation results, etc. of which were indicated in Table 2.

### Example 2

18.64 parts by weight of the vinyl functional polydimethylsiloxane of component A,
4.66 parts by weight of the methyl-terminated high molecular weight polydimethylsiloxane of component A′,
40.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
2.0 parts by weight of Tetraethoxysilane of component D,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 33.

The composition was cured via the abovementioned method, after which the adhesive force on the glass slides were measured via the abovementioned method, the evaluation results, etc. of which were indicated in Table 2.

### Example 3

16.31 parts by weight of the vinyl functional polydimethylsiloxane of component A,
6.99 parts by weight of the methyl-terminated high molecular weight polydimethylsiloxane of component A′,
45.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
2.0 parts by weight of Tetraethoxysilane of component D,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 37.

The composition was cured via the abovementioned method, after which the adhesive force on the glass slides were measured via the abovementioned method, the evaluation results, etc. of which were indicated in Table 2.

### Example 4

13.98 parts by weight of the vinyl functional polydimethylsiloxane of component A,
9.32 parts by weight of the methyl-terminated high molecular weight polydimethylsiloxane of component A′,
45.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
2.0 parts by weight of Tetraethoxysilane of component D,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 44.

The composition was cured via the abovementioned method, after which the adhesive force on the glass slides were measured via the abovementioned method, the evaluation results, etc. of which were indicated in Table 2.

### Example 5

11.65 parts by weight of the vinyl functional polydimethylsiloxane of component A,
11.65 parts by weight of the methyl-terminated high molecular weight polydimethylsiloxane of component A′,
45.00 parts by weight of the Trimethylsilyl-capped MQ resin of component B,
23.30 parts by weight of toluene of component G,
0.4 parts by weight of Poly(dimethylsiloxane-co-methylhydrogen)siloxane, trimethylsilyl-end-capped of component C,
2.0 parts by weight of Tetraethoxysilane of component D,
0.2 parts by weight of 1-ethynyl-1-cyclohexanol of component F,
were sufficiently mixed at room temperature,
after which 0.36 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 52.

The composition was cured via the abovementioned method, after which the adhesive force on the glass slides were measured via the abovementioned method, the evaluation results, etc. of which were indicated in Table 2.

### Reference Example 1

16.31 parts by weight of the vinyl functional polydimethylsiloxane of component A,
6.99 parts by weight of the methyl-terminated high molecular weight polydimethylsiloxane of component A′,
65.37 parts by weight of the Trimethylsilyl-capped MQ resin of component B,
23.30 parts by weight of toluene of component G,
0.34 parts by weight of Poly(dimethylsiloxane-co-methylhydrogen)siloxane, trimethylsilyl-end-capped of component C,
0.06 parts by weight of 1-ethynyl-1-cyclohexanol of component F,
were sufficiently mixed at room temperature,
after which 0.25 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 32.

The composition was cured via the abovementioned method, after which the adhesive force on the PMMA plates were measured via the abovementioned method, the evaluation results, etc. of which were indicated in Table 2.

### Reference Example 2

16.31 parts by weight of the vinyl functional polydimethylsiloxane of component A,
6.99 parts by weight of the methyl-terminated high molecular weight polydimethylsiloxane of component A′,
65.37 parts by weight of the Trimethylsilyl-capped MQ resin of component B,
23.30 parts by weight of toluene of component G,
0.11 parts by weight of Poly(dimethylsiloxane-co-methylhydrogen)siloxane, trimethylsilyl-end-capped of component C,
0.06 parts by weight of 1-ethynyl-1-cyclohexanol of component F,
were sufficiently mixed at room temperature,
after which 0.25 parts by weight of the platinum based hydrosilylation reaction catalyst of component E was added to the mixture to form a curing reactive organopolysiloxane composition.

The molar ratio (SiH/Vi ratio) of SiH groups in component (E) to the amount of alkenyl groups in component (A) was 10.

The composition was cured via the abovementioned method, after which the adhesive force on the PMMA plates were measured via the abovementioned method, the evaluation results, etc. of which were indicated in Table 2.

TABLE 2

| | | | | | | | | | Adhesive |
|---|---|---|---|---|---|---|---|---|---|
| | | | | | | | | | force |
| Component | (A) | (A′) | (B) | (F) | (C) | (D) | (E) | (G) | (gf/inch) |
| Example 1 | 18.64 | 4.66 | 40.00 | 0.20 | 0.40 | 1.00 | 0.36 | 23.30 | 848 |
| Example 2 | 18.64 | 4.66 | 40.00 | 0.20 | 0.40 | 2.00 | 0.36 | 23.30 | 1008 |
| Example 3 | 16.31 | 6.99 | 45.00 | 0.20 | 0.40 | 2.00 | 0.36 | 23.30 | 915 |
| Example 4 | 13.98 | 9.32 | 45.00 | 0.20 | 0.40 | 2.00 | 0.36 | 23.30 | 951 |
| Example 5 | 11.65 | 11.65 | 45.00 | 0.20 | 0.40 | 2.00 | 0.36 | 23.30 | 964 |
| Comparative | 18.64 | 4.66 | 40.00 | 0.20 | 0.40 | | 0.36 | 23.30 | 612 |
| Example 1 | | | | | | | | | |
| Comparative | 16.31 | 6.99 | 45.00 | 0.20 | 0.40 | | 0.36 | 23.30 | 685 |
| Example 2 | | | | | | | | | |
| Comparative | 13.98 | 9.32 | 45.00 | 0.20 | 0.40 | | 0.36 | 23.30 | 670 |
| Example 3 | | | | | | | | | |
| Comparative | 11.65 | 11.65 | 45.00 | 0.20 | 0.40 | | 0.36 | 23.30 | 618 |
| Example 4 | | | | | | | | | |
| Comparative | 16.31 | 6.99 | 65.37 | 0.06 | 0.053 | | 0.25 | 23.30 | 440* (cohesive |
| Example 5 | | | | | | | | | failure) |
| Reference | 16.31 | 6.99 | 65.37 | 0.06 | 0.34 | | 0.25 | 28.6 | 1730 |
| Example 1 | | | | | | | | | 2220* |
| Reference | 16.31 | 6.99 | 65.37 | 0.06 | 0.11 | | 0.25 | 28.6 | 2160* |
| Example 2 | | | | | | | | | |

*Adhesive force measured against PMMA plate.

As indicated in Table 2, the silicone-based PSA layer-forming compositions according to Examples 1 to 5 using tetraethoxysilane (TEOS) as anchorage additive provide improved adhesive force by 34 to 65% in comparison with same composition but lacking TEOS (=component (C)). Specifically, comparisons for adhesive force in Examples 1 and 2 vs. Comparative Examples 1 (increased by 39 and 65%); Examples 3 vs. Comparative Example 2 (increased by 34%); Examples 4 vs. Comparative Example 3 (increased by 42%); and Examples 5 vs. Comparative Example 4 (increased by 65%) indicate that adhesive force in Examples was clearly increased and/or improved compared with corresponding Comparative Examples by using TEOS.

Furthermore, the SiH/vinyl ratio for Examples 1-5 and Comparative Examples 1-4 was in a range of 33-52. In Reference examples 1 and 2, the SiH/vinyl ratio is 32 and 10, respectively. The peel adhesive force to PMMA for these two Reference examples were 2200 gf/inch, indicating good cure. In Comparative Example 5 with the SiH/vinyl ratio of 5.0, however, the adhesion value to PMMA was 440 gf/inch with cohesion failure of the PSA, indicating that the SiH/vinyl ratio>5 is preferred to achieve the technical benefit in this invention.

1. A silicone-based pressure sensitive adhesive layer-forming composition comprising:
(A) a linear organopolysiloxane having greater than one alkenyl group on average per molecule;
(B) an organopolysiloxane resin, wherein the total content of hydroxyl groups and hydrolysable groups with respect to all silicon atoms in the molecule is 2.0 mass % or less;
(C) an organohydrogenpolysiloxane having at least two Si—H bonds in the molecule;
(D) at least one of tetraalkoxysilane or a prepolymer thereof; and
(E) a hydrosilylation reaction catalyst;
wherein the mass ratio of component (B) to component (A) is within a range of 0.5 to 3.5, and the amount of component (D) based on total mass of components (A) to (C) is within a range of 0.1 to 9.0 mass %.

2. The silicone-based pressure sensitive adhesive layer-forming composition according to claim 1, wherein component (D) comprises tetramethoxysilane, tetraethoxysilane, or a mixture thereof.

3. The silicone-based pressure sensitive adhesive layer-forming composition according to claim 1, wherein:
50 to 100 mass % of component (A) is (A1) a raw rubber-like alkenyl group-containing organopolysiloxane having a viscosity of 100,000 mPa·s or more at 25° C. or having a plasticity number within a range of 50 to 200 as measured in accordance with a method as described in JIS K6249, and the content of a vinyl (CH₂═CH—) moiety of alkenyl group is within a range of 0.005 to 0.400 mass %;
component (B) is (B1) an organopolysiloxane resin or mixture thereof which consists essentially of R³SiO_{1/2} units and SiO_{4/2} units, where R is a monovalent organic group, and 90 mole % or more of R is an alkyl group having 1 to 6 carbon atoms or a phenyl group;
component (C) is present in an amount such that the molar ratio of the amount of SiH groups in the component (C) to the total amount of the alkenyl groups in components (A) and (B) is 7 to 100; and
component (E) is a platinum-based catalyst and is present in an amount such that the content of a platinum-based metal in a solid content of the composition is within a range of 0.1 to 200 ppm in the silicone-based pressure sensitive adhesive-forming composition excluding solvents.

4. The silicone-based pressure sensitive adhesive layer-forming composition according to claim 1, further comprising (A′) a linear organopolysiloxane which does not contain a carbon-carbon double bond-containing reactive group in the molecule.

5. The silicone-based pressure sensitive adhesive layer-forming composition according to claim 4, wherein 50 to 100 mass % of component (A′) is (A′1) a raw rubber-like organopolysiloxane having a viscosity of 100,000 mPa·s or more at 25° C. or having a plasticity number within a range of 50 to 200 as measured in accordance with a method as described in JIS K6249.

6. The silicone-based pressure sensitive adhesive layer-forming composition according to claim 1, wherein:
50 to 100 mass % of component (A) is (A1) a raw rubber-like alkenyl group-containing organopolysiloxane having a viscosity of 100,000 mPa·s or more at 25° C. or having a plasticity number within a range of 50 to 200 as measured in accordance with a method as described in JIS K6249, and the content of a vinyl (CH₂═CH—) moiety of alkenyl group is within a range of 0.005 to 0.400 mass %;
50 to 100 mass % of optional component (A′) is (A′1) a raw rubber-like organopolysiloxane having a viscosity of 100,000 mPa·s or more at 25° C. or having a plasticity number within a range of 50 to 200 as measured in accordance with a method as described in JIS K6249; and
the mass ratio of component (A) to component (A′) ranges from 100:0 to 40:60.

7. The silicone-based pressure sensitive adhesive layer-forming composition according to claim 1, wherein component (C) is present in an amount such that the molar ratio of the amount of SiH groups in component (C) to the total amount of the alkenyl groups in components (A) and (B) is 7 to 60.

8. The silicone-based pressure sensitive adhesive layer-forming composition according to claim 1, wherein the adhesive force of a pressure sensitive adhesive layer having a thickness of 50 μm obtained by curing the composition, as measured at a tensile speed of 300 mm/min using a 180° peeling test method according to JIS Z 0237 for glass substrate, is more than 20% greater than that for the pressure sensitive adhesive layer obtained from the same composition but lacking component (D).

9. The silicone-based pressure sensitive adhesive layer-forming composition according to claim 1, wherein the adhesive force of a pressure sensitive adhesive layer having a thickness of 50 μm obtained by curing the composition, as measured at a tensile speed of 300 mm/min using a 180° peeling test method according to JIS Z 0237 for glass substrate, is within a range of 800 to 3000 gf/inch.

10. A pressure sensitive adhesive layer obtained by curing the silicone-based pressure sensitive adhesive layer-forming composition according to claim 1.

11. A laminated body comprising a pressure sensitive adhesive layer obtained by curing the silicone-based pressure sensitive adhesive layer-forming composition according to claim 1 on a film-like substrate.

12. The laminated body according to claim 11, wherein a release layer for the pressure sensitive adhesive layer is provided on one or two or more film-like substrates.

13. The laminated body according to claim 11, comprising:
a film-like substrate;
a first release layer formed on the film-like substrate;
a pressure sensitive adhesive layer formed by applying and curing the silicone-based pressure sensitive adhesive layer-forming composition on the release layer; and
a second release layer laminated on the pressure sensitive adhesive layer.

14. An elastic adhesive member obtained by curing the silicone-based pressure sensitive adhesive layer-forming composition according to claim 1.

15. An electronic equipment or electrical device comprising the elastic adhesive member according to claim 1.
